(19) United States
(12) Patent Application Publication
(10) Pub. No.: US 2004/0134121 A1
(43) Pub. Date: Jul. 15, 2004

(54) Insect bait container and method for producing an insect bait container

(76) Inventors: Alessandro Bianchini, Modena (IT); Pierangelo Dodi, Modena (IT)

Correspondence Address: Flynn Thiel Boutell & Tanis, 2026 Rambling road, Kalamazoo, MI, 49008-1631, US

(21) Appl. No.: 10/472,538

(22) PCT Filed: Mar. 19, 2002
(86) PCT No.: PCT/EP02/03004

(30) Foreign Application Priority Data
Mar. 22, 2002 (IT) M001A000052

(51) Int. Cl. A01M 1/20

(52) U.S. Cl. 43/131

(57) ABSTRACT

Container means of baits (2) comprises wall means (5, 6) internally to which a containing region (16) is provided of bait means (2) and comprising a peelable back portion (19) suitable for defining, after opening, a passage (4) for at least one subject for which said bait means (2) is designed; the container means comprises as well a containing region (16) of bait means (2) and notching line means (26) identifying into said wall means (5, 6) removable closing means (25) of said passage (4).

The invention relates to a container inside which a bait for insects is placed and a method for producing such a container. Containers are known, comprising an internal region wherein a bait for insect is housed, in the form of liquid and/or solid substance, and at least one opening arranged so that the insects may enter inside the containers, pick up a certain amount of bait and exit from the containers by bringing that certain amount of bait inside the refuges where they normally live.

The bait may be ingested by the insects, or may deposit itself by contact on external portions of their bodies. When the insects, that were contaminated by the bait, bring themselves into the refuges where they leave in colonies, they contaminate also the environments of such refuges by spreading important amounts of bait there. Furthermore, the infected insects come in contact with other insects of the colony, by contaminating so also these later.

Since the bait employed into such containers contains an insecticidal substance acting after a certain delay, also numerous individuals of the colonies, that did not come directly in contact with the bait of the container, but received a certain amount of the bait by contact with the infected individuals and/or the surfaces of the refuges contaminated by these later, are interested by the insecticidal action.

Thus, it is possible to obtain an insecticidal effect highly more efficient than the conventional systems, where only the individuals directly interested by the action of an insecticidal substance may be suppressed.

The known containers of baits for insects are initially hermetically closed, since it would be dangerous that their contents were spread in uncontrolled manner, and may be opened only by cutting away an end portion of them with the scissors, so as to make possible that the insects enter inside them in order to come in contact with the bait.

This represents a serious drawback, since even the scissors used for opening such containers are contaminated by the bait and then by the insecticidal substance too contained in this later and therefore must be cleared when they are used for other usage, as usually this takes place with the scissors for domestic usage.

When a user does not recognize that and uses the scissors without adopting the necessary care, for example for opening containers of food products, also these later are contaminated by the bait, with serious damage for health.

Furthermore, opening a container of baits of the type described above produces a main portion of container containing the bait and a waste portion of container that must be disposed. As a result, even the waste portion of the container results contaminated by the bait and therefore must be handled with great care. In practice, however, in domestic environments, it is practically impossible to assure that the waste portion of the container is not wrongly handled, for example by children, or domestic animals, which, therefore, are exposed, despite themselves, to the damaging effects of the insecticidal substance.

A purpose of the invention is to improve the known containers of baits.

A further-purpose of the invention is to make easier opening the containers of baits for insects.

Another purpose of the invention is to make available a container of baits for insects that does not require the employment of tools for opening.

A still further purpose of the invention is to provide a container of baits for insects that is more reliable for man and the environment.

In a first aspect of the invention, container means of baits is provided, comprising wall means internally to which a containing region of bait means is provided, characterized in that, said wall means comprises a peelable back portion suitable for defining, after opening, a passage for at least one subject for which said bait means is designed.

In an advantageous version, the container comprises a first portion and a second portion, joined along a perimetric border, the first portion being provided with a first end section joined in a peelable back manner with a second end section of the second portion.

The first section may so be removed from the second section in order to clear the entry towards the above-mentioned passage.

In a further advantageous version, the first section, after being moved away from the second section, may be separated from the first portion by being torn along a preferred separating line, for example a notching line crossing the first portion, enabling, thus, the said passage to be opened.

In a still further advantageous version, the second section forms, after opening, a ramp suitable for enabling the subject to enter inside the interior of the container and exit from there.

In a second aspect of the invention, container means of baits is provided, comprising wall means comprising a containing region of bait means and a passage for at least one subject for which said bait means is designed, characterized in that, said wall means comprises preferred separating line means identifying, in said wall means, removable closing means of said passage.

Preferably, the preferred separating line means comprises notching line means crossing said wall means.

Owing to these aspects of the invention it is possible to obtain a container of baits for insects whose opening is simple and not dangerous. The user, actually, can clear the entry inside the container without using cutting means and without exposing himself to the contact with the insecticidal substance with which the baits are contaminated.

In a third aspect of the invention, a method is provided for producing container means, comprising forming wall means of said container means, introducing inside said wall means a certain amount of bait means, sealing said wall means, characterized in that, said forming comprises forming a peelable back portion of said wall means, said peelable back portion being suitable for defining, after opening, a passage for at least one subject for which said bait means is designed.

In a fourth aspect of the invention, a method is provided for producing container means of bait means for insects, comprising forming, in said container means, container body means and a passage for at least one subject for which said bait means is designed, introducing inside said body means a certain amount of said bait means, sealing said body means, characterized in that, said forming comprises achieving in said body means preferred separating line means delimiting in said body means removable closing means of said passage.

Owing to these aspects of the invention, it is possible to obtain a method for producing containers of baits for insects resulting suitable for being opened in a simple and reliable manner.

In a fifth aspect of the invention, a method is provided for opening container means initially enclosing bait means at its interior, in order to make available said bait means to subjects for which said bait means is designed, characterized in that, said opening comprises mutually separating first peelable back portions and second peelable back portions of said container means.

In a sixth aspect of the invention, a method is provided in order to open container means initially enclosing bait means at its interior in order to make available said bait means to subjects for which said bait means is designed, characterized in that, said opening comprises removing from said container means respective end portions by tearing them along notching line means.

Owing to these aspects of the invention it is possible to obtain a method for opening containers of baits for insects not requiring the use of cutting tools by the user. The method according to the invention further prevents the said user from possible contamination by the insecticidal substance contained in the baits.

The invention may be better understood and carried out with reference to the enclosed drawings, that illustrate some exemplifying and not restrictive embodiment forms thereof, wherein:

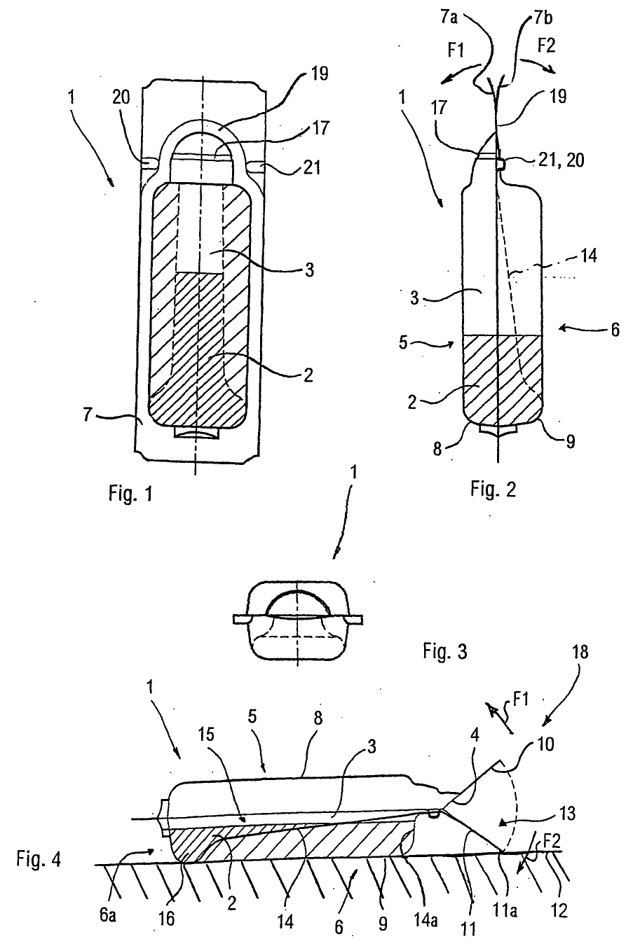

FIG. 1 is a front view of a container according to the invention;

FIG. 2 is a side view of the container of FIG. 1;

FIG. 3 is a top view of the container of FIG. 1;

FIG. 4 is a view like FIG. 2 highlighting the container opened and placed on a supporting plane;

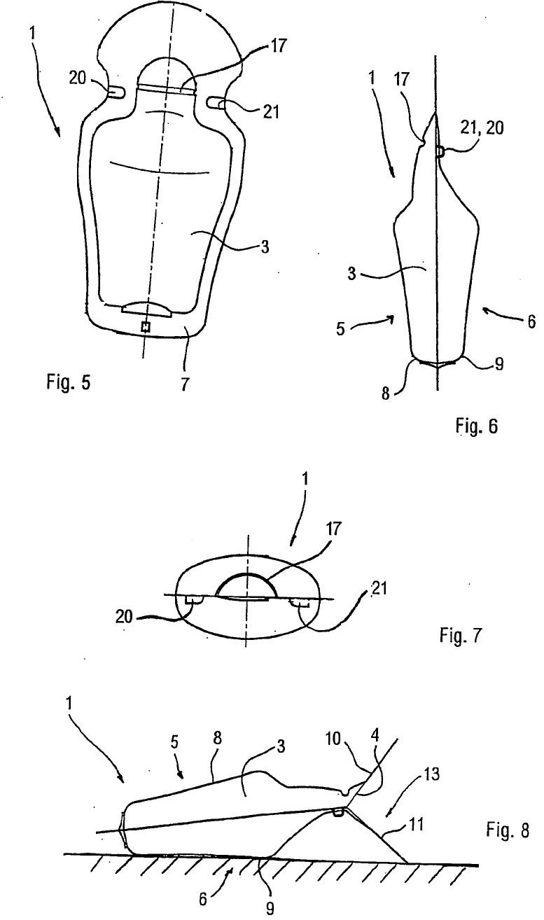

FIG. 5 is a front view of a preferred version of a container according to the invention;

FIG. 6 is a side view of the container of FIG. 5;

FIG. 7 is a top view of the container of FIG. 5;

FIG. 8 is a view like FIG. 5 highlighting the container opened and placed on a supporting plane;

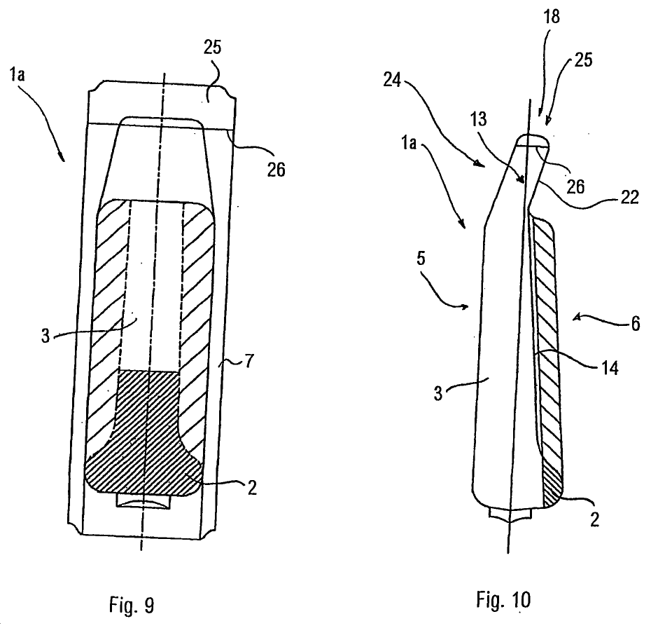

FIG. 9 is a front view of another preferred version of a container according to the invention;

FIG. 10 is a side view of the container of FIG. 9;

FIG. 11 is a top view of the container of FIG. 9 wherein the opening operations of the same container are sketched;

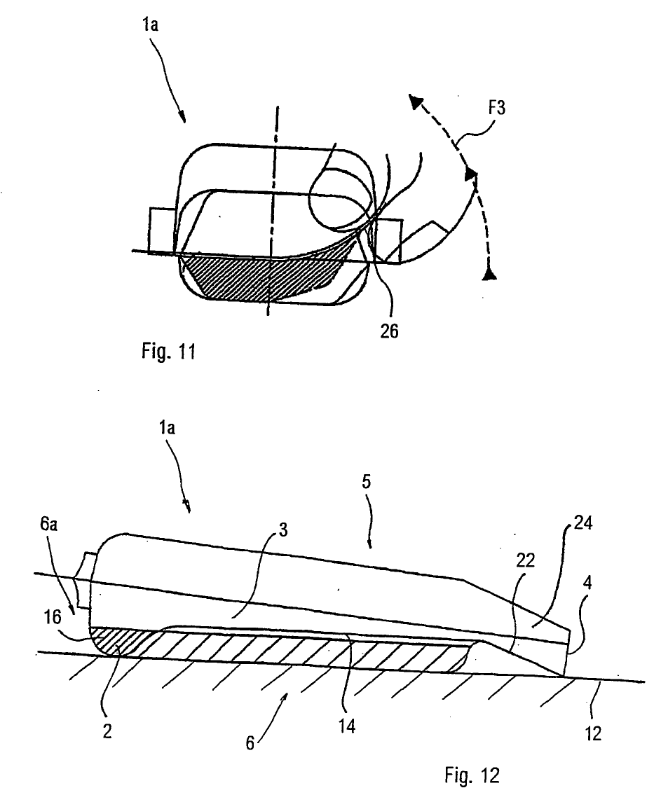

FIG. 12 is a view like FIG. 10 highlighting the container opened and placed on a supporting plane;

FIG. 13 is a front view of a further preferred version of a container according to the invention;

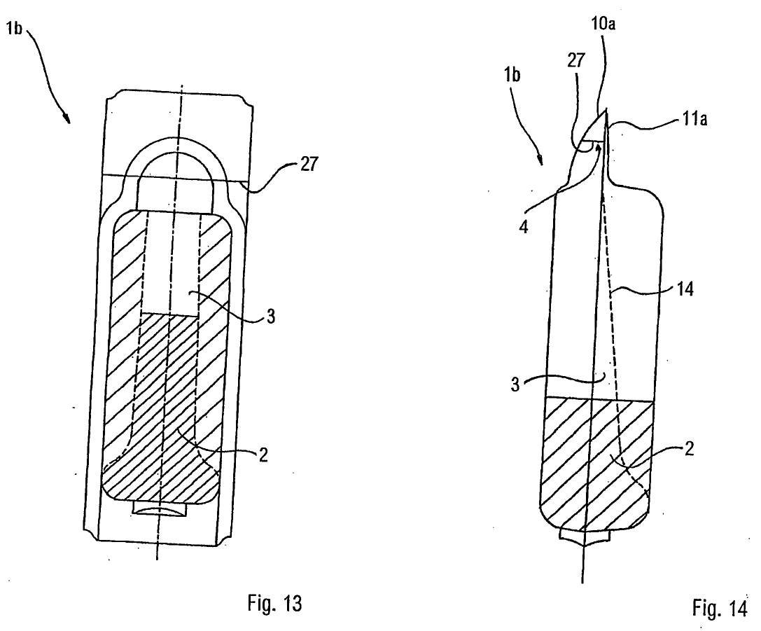

FIG. 14 is a side view of the container of FIG. 13;

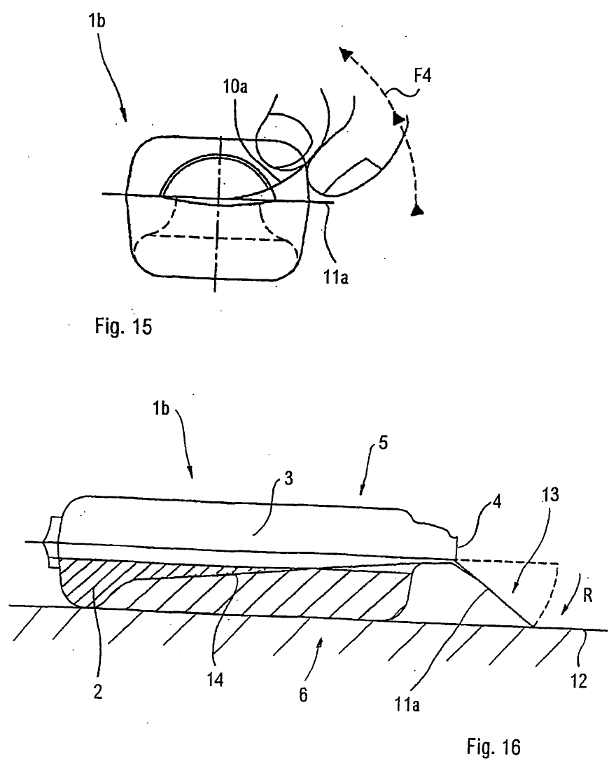

FIG. 15 is a top view of the container of FIG. 13 wherein the opening operations of the same container are sketched;

FIG. 16 is a view like FIG. 14 highlighting the container opened and placed on a supporting plane.

With reference to the FIGS. 1 to 8, a container 1 is shown of a bait 2 for insects, the bait comprising an insecticidal substance at the liquid and/or solid state, acting on the said insects with a lethal, deferred action. The container 1 comprises a container body 3 defining a space suitable for receiving the said bait 2 and an end 18 suitable for being opened wherein a passage 4 may be obtained suitable for allowing the entry of the insects into the container 1, enabling so these lather to be contaminated with the insecticidal substance.

The container 1 comprises a first portion 5 and a second portion 6 mutually welded along a peripheral border 7 so as to delimit the said body 3.

The first portion 5 and the second portion 6 are mutually welded so as to identify, at an end of the container 1, a peelable back portion 19.

The first portion 5 and the second portion 6 may be obtained for example by thermoforming respectively a first sheet 8 and a second sheet 9 of thermoformable material. Advantageously, the first sheet 8 and the second sheet 9 may be heated and previously mutually welded along a peripheral border 7 in order to give place to a plurality of pre-forms of container. Successively, the pre-forms obtained in this manner, as a consequence of proper forming, for example by injection inside them of compressed air, give place to respective containers 1 that are filled with bait 2 that is introduced in these lather through openings made at their upper portion.

Thereafter, such openings are sealed and the containers 1 are separated from non-thermoformed regions of the first sheet 8 and the second sheet 9.

A first end section 10 of the first portion 5 results welded in peelable back manner with a respective second end section 11 of the second portion 6, so as to identify the said peelable back portion 19.

At the usage, a user, after having caught non-welded strips 7a, 7b of the first portion 5 and the second portion 0.6 placed externally to the border 7, separates the first section 10 from the second section 11 and moves them mutually away by rotating them with respect to the body 3 in the directions indicated by the arrows F1, F2 so as to clear the access to the passage 4.

The container 1 is then positioned on a supporting plane 12, for example a floor. The part 11a of the second portion 11, resulting farther from the body 3, is placed in contact with an its own free border with the supporting plane 12 so as to constitute an access ramp 13 enabling the insects to reach the bait 2.

The second portion 6 is formed so as to show, internally to the body 3, an inclined wall 14a that, once the containers 1 has been opened and positioned on respective supporting plane 12, prevents the bait 2 from flowing out through the passage 4, and chute means 14 enabling the insects to come in contact with the bait 2 and to easily move away from the body 3 after being contaminated by the insecticidal substance.

The second portion 6 further comprises, at its end 6a opposing the second section 11, a tank 16 for the bait 2 surrounding on three sides the chute means 14.

The first portion 5 further comprises fold stabilising means 17 that comprises, for example, a groove made on the first portion 5 so as to weaken said first portion 5, by making so easy the rotation of the first section 10.

At the end regions of the first section 10 and the second section 11, at opposing sides of the border 7, a pair of locking elements 20, 21 is provided, arranged for firmly fixing the first portion 5 with the second portion 6 in order to delimit the peelable back portion 19 and preventing, during the opening phase of the container, a complete, mutual separation of the said first portion 5 and second portion 6.

With reference to the FIGS. 9 to 12, another version of container 1a is shown, substantially analogous to the container 1 previously described, wherein the second portion 6 shows the inclined wall 14, arranged internally to the body 3, joined with a further inclined wall 22 having an opposed slope with respect to the inclined wall 14 and extending externally to the body 3, towards the end 18 suitable for being opened.

At the further inclined wall 22, the first portion 5 is profiled so as to identify a transit pipe 24 for the insects towards the container 1 leading to the end 18, suitable for being opened, initially sealed by means of a strip 25 fixed thereto along a notching line 26 identified by cuts interesting both the first portion 5 and the second portion 6. At the usage, a user, after having held the strip 25, as shown in FIG. 11, can tear it from the body 3 along the nothing line 26 by rotating the strip 25 according to the direction shown by the arrow F3, in order to clear the passage 4.

Once such operation was carried out, the user places the container 1 on the supporting plane 12 so that a free border of the further wall 22 comes in contact with this last plane 12 for giving place to the ramp 13 enabling the insects to access the body 3.

In this manner the employment is prevented of scissors, or other cutting means, and their consequent contamination with the insecticidal substance.

With reference to the FIGS. 13 to 16, a further version is shown of container 1b, substantially analogous to the containers 1 and 1a previously described, wherein the first portion 5 and the second portion 6 show respectively a first section 10a and a second section 11a welded in a peelable back manner in order to close the passage 4, similarly to what described with reference to the FIGS. 1 to 8. The first section 10a is identified in the first portion 5 by means of a preferred separating line 27 made by means of cuts interesting only the said first portion 5.

At the moment of opening the container 1b, a user catches the first section 10a and, initially, moves it away from the second section 11a by rotating the first section 10a according to the direction identified by the arrow F4. Then, the first section 10a is separated from the first portion 5 by tearing the first section 10a from the first portion 5 along the preferred separating line 27 in order to clear the passage 4, whereas the second section 11a may be rotated according to the direction indicated by the arrow R in order to give place to the access ramp 13 for the insects.

1. Container means of baits (2), comprising wall means (5, 6) internally to which a containing region is provided (16) of bait means (2), characterized in that, said wall means (5, 6) comprises a peelable back portion (19) suitable for defining, after opening, a passage (4) for at least one subject for which said bait means (2) is designed.

2. Container means according to claim 1, wherein said passage (4) is defined by regions of said wall means (10, 11; 10a, 11a).

3. Container means according to claim 2, wherein said regions comprise first portions of sheet material (10, 10a) joined to second portions of sheet material (11, 11a) along a border (7) of said container means (1; 1a).

4. Container means according to claim 3, wherein said first portions (10; 10a) and/or said second portions (11; 11a) are identified in said wall means (5, 6) by preferred, separating line means (27).

5. Container means according to claim 4, wherein said first portions (10; 10a) and/or said second portions (11, 11a) may be moved away from said wall means (5, 6) by tearing them along said preferred, separating line means (27).

6. Container means according to any of claims 3 to 5, wherein said peelable back portion (19) is defined along a section of said border (7).

7. Container means according to any of the preceding claims, wherein said passage (4) is associated with transit means (13) for entering into, and exiting from said container means (1; 1a).

8. Container means according to claim 7 when depending from any of claims 3 to 6, wherein said transit means (13) is comprised at least in one of said first portions (10; 10a) or said second portions (11, 11a).

9. Container means according to any of the preceding claims and further comprising inhibiting means of back peelability (20, 21) arranged for limiting said peelable back portion (19).

10. Container means according to claim 9 when depending from any of claims 3 to 6, or from claim 7 when claim 7 depends from any of claims 3 to 6, or from claim 8, wherein said inhibiting means of back peelability (20, 21) is arranged along said border (7).

11. Container means according to any of claims 3 to 6, or according to any of claims 7 to 10 when depending from any of claims 3 to 6, and further comprising fold starting means (18) arranged for facilitating the mutual separation of said first portions (10; 10a) from said second portions (11; 11a).

12. Container means of baits, comprising wall means (5, 6) comprising a containing region (16) of bait means (2) and a passage (4) for at least a subject for which said bait means (2) is designed, characterized in that, said wall means (5, 6) comprises preferred separating line means (26) identifying in said wall means (5, 6) removable closing means (25) of said passage (4).

13. Container means according to claim 12, wherein said preferred separating line means comprises notching line means (26).

14. Container means according to claim 12, or 13, wherein said passage (4) is defined by regions of said wall means (5, 6).

15. Container means according to claim 14, wherein said regions comprise first portions of sheet material (5) joined to second portions of sheet material (6) along a border (7) of said container means (1a).

16. Container means according to claim 15, wherein said preferred separating line means (26) crosses said container means by joining opposing sides of said border (7).

17. Container means according to any of claims 12 to 16, wherein said passage (4) is associated with transit means (13) suitable for enabling to enter inside, and exit from, the interior of said container means (1b).

18. Container means according to claim 17, wherein said transit means comprises ramp means (13).

19. Container means according to any of claims 12 to 19, and further comprising joining means (14) suitable for joining said containing region (16) with said transit means (13).

20. Container means according to claim 19, wherein said joining means comprises inclined wall means (14) having descending development by proceeding from said joining means (13) towards said containing region (16) in order to prevent outflows of said bait means (2) from said containing region (16).

21. Method for producing container means (1; 1a), comprising forming wall means (5, 6) of said container means (1; 1a), introducing inside said wall means (5, 6) a certain amount of bait means (2), sealing said wall means (5, 6), characterized in that, said forming comprises forming a peelable back portion (19) of said wall means, said peelable back portion (19) being suitable for defining, after opening, a passage (4) for at least one subject for which said bait means (2) is designed.

22. Method according to claim 21, wherein said forming comprises forming said passage (4) between regions of said wall means (10, 11; 10a, 11a).

23. Method according to claim 21, or 22, wherein said forming comprises forming first portions of sheet material (10, 10a) and second portions of sheet material (11, 11a) joined along a border (7) of said container means.

24. Method according to any of claims 21 to 23, wherein said forming comprises obtaining into said wall means (5, 6) preferred separating line means (26) in order to delimit in said wall means (5, 6) said first portions (10; 10a) or said second portions (11; 11a).

25. Method according to claim 23, or 24, wherein said forming comprises defining said peelable back portion (19) in a section of said border (7).

26. Method according to any of claims 21 to 25, and further comprising deforming at least one of said first portions (10; 10a) or said second portions (11, 11a) in order to obtain, near said passage (4), transit means (13) for entering inside, or exiting from, the interior of said container means (1; 1a).

27. Method according to any of claims 21 to 26, and further comprising achieving in said container means (1; 1a) inhibiting means of back peelability (20, 21) arranged for limiting said peelable back region (19).

28. Method according to any of claims 21 to 27, and further comprising obtaining into said container means (1; 1a) fold starting means (18) arranged for facilitating the mutual separation of said first portions (10; 10a) from said second portions (11; 11a).

29. Method for producing container means (1b) of bait means (2) for insects, comprising forming into said container means (1b) container body means (3) and a passage (4) for at least one subject for which said bait means are designed, introducing inside said container body means (3) a certain amount of said bait means (2), sealing said container body means (3), characterized in that, said forming comprises achieving in said container body means (3) preferred separating means (26) delimiting in said container body means (3) removable closing means (25) of said passage (4).

30. Method according to claim 29, wherein said achieving comprises notching said body means in order to obtain said preferred separating means (26).

31. Method according to claim 29, or 30, and further comprising achieving, near said passage (4), transit means (13) for entering inside, or exiting from, said container means (1; 1a).

32. Method according to any of claims 29 to 31, wherein said forming comprises forming first portions of sheet material and second portions of sheet material mutually joined along a border (7).

33. Method according to claim 31, or 32, and further comprising obtaining into said container means (1, 1a, 1b) joining means (14) suitable for joining said transit means (13) with an interior of said container means (1, 1a, 1b).

34. Method according to claim 33, wherein said obtaining comprises obtaining inclined wall means (14) having descending development by proceeding from said joining means (13) towards said interior in order to prevent outflows of said bait means (2) from said container means (1; 1a; 1b).

35. Method for opening container means (1; 1a) initially enclosing bait means (2) at its interior in order to make said bait means (2) available to subjects for which said bait means (2) is designed, characterized in that said opening comprises mutually separating first peelable back portions (10, 10a) and second peelable back portions (11, 11a) of said container means (1; 1a).

36. Method according to claim 35, wherein after said separating it is provided moving away said first portions (10, 10a) from said second portions (11, 11a) in order to define in said container means (1; 1a) a passage (4) for the transit of said subjects.

37. Method according to claim 35, or 36, wherein, after said separating, it is provided removing said first portions (10a) from said container means (1a).

38. Method according to claim 37, wherein said removing comprises tearing said first portions (10a) along preferred separating line means (27).

39. Method according to any of the preceding claims, wherein after said separating it is provided rotating said second portions (11, 11a) in order to achieve in said container means (1; 1a) transit means (13) for entering inside, or exiting from, the interior of said container means (1; 1a).

40. Method for opening container means (1b) initially enclosing bait means (2) at its interior in order to make said bait means (2) available for subjects for which said bait means (2) is designed, characterized in that, said opening comprises removing from said container means (1b) respective end portions (25) by tearing them along notching line means (26).
